(19) United States
(12) Patent Application Publication
(10) Pub. No.: US 2015/0078611 A1
(43) Pub. Date: Mar. 19, 2015

(54) JOINT SPEAKER SURROUND AND GASKET, AND METHODS OF MANUFACTURE THEREOF

(71) Applicant: Apple Inc., Cupertino, CA (US)

(72) Inventors: Brad G. Boozer, Cupertino, CA (US); Craig M. Stanley, Campbell, CA (US); John J. Baker, Cupertino, CA (US); Nathan P. Bosscher, Cupertino, CA (US); Phillip Hobson, Menlo Park, CA (US)

(73) Assignee: Apple Inc., Cupertino, CA (US)

(21) Appl. No.: 14/027,808

(22) Filed: Sep. 16, 2013

(51) Int. Cl. H04R 7/04; H04R 31/00

(52) U.S. Cl. CPC H04R 7/04; H04R 31/003
USPC 381/398; 29/594

(57) ABSTRACT

A joint speaker surround and gasket. The speaker surround of the joint speaker surround and gasket is formed of a surround material and has an inner edge defining a speaker cone aperture shaped to match a speaker cone and an outer edge portion shaped to match a housing. The gasket of the joint speaker surround and gasket is formed of a gasket material. The gasket is integrally bonded to the outer edge portion of the speaker surround.

### BACKGROUND

1. Field of the Disclosure

This application generally relates to speaker mounts and methods of manufacturing thereof, and relates particularly to joint speaker surrounds and gaskets and methods of manufacturing thereof.

2. Background of the Disclosure

There are many different kinds of speaker drivers, or speakers, but they all do basically the same thing: create sound waves. By far the most common type of speaker is the moving coil electrodynamic piston driver. It has a moving part called a diaphragm that acts like a piston to pump air and thereby create sound waves.

A speaker has a number of parts. These include motor parts, diaphragm parts, suspension parts, and frame parts. The motor parts include the magnet and voice coil and provide the power to drive the speaker diaphragm. The primary diaphragm part is the cone, which is coupled to the voice coil and moves like a piston to pump air and create sound waves. The diaphragm may also include a dust cap to cover the hole in the center of the cone. The mass of the moving parts (the cone, dust cap, voice coil and former) and the compliance of the suspension (surround and spider) control the resonance of the driver which in turn controls its low-frequency response.

The suspension parts include the spider and the surround. These two parts form the suspension of the speaker. The speaker surround couples the outer edge of the speaker cone to the frame of the speaker (or sometimes to the housing of a device containing the speaker the speaker). The spider couples the inner edge of the speaker cone to the speaker frame. The suspension fulfills several purposes: it centers (both axially and front-to-back) the voice coil in the gap of the magnet circuit and it exerts a restoring force to keep it there and it limits the maximum mechanical excursion of the diaphragm and voice coil. Together with the mass of the moving parts the suspension determines the resonance of the speaker. Ideally, the suspension should provide a linear restoring force on the diaphragm and voice coil over its full range of excursion.

The speaker frame, also called the “basket” or “chassis”, provides a rigid structure to which the speaker components are mounted. It is designed so that all of the speaker components may be aligned properly. The frame can also aid the motor parts in dissipating heat away from the voice coil. It is commonly made of stamped steel, cast aluminum or plastic. It is generally useful for the speaker to form a mechanically rigid and airtight seal with the housing. Many speakers include a front gasket to provide a smooth and flat mounting surface between the speaker frame and the housing of the device containing the speaker. The improved mounting quality permitted by the gasket allows the speaker to project sound with greater fidelity to the driving signal supplied to the speaker.

### BRIEF SUMMARY OF THE DISCLOSURE

One example embodiment, as described herein, is a joint speaker surround and gasket. The speaker surround of the joint speaker surround and gasket is formed of a surround material and has an inner edge defining a speaker cone aperture shaped to match a speaker cone and an outer edge portion shaped to match a housing. The gasket of the joint speaker surround and gasket is formed of a gasket material. The gasket is integrally bonded to the outer edge portion of the speaker surround.

Another example embodiment, as described herein, is a method of manufacture of a joint speaker surround and gasket. A speaker surround is formed from a speaker surround blank. The speaker surround includes an outer edge portion and an inner edge defining a speaker cone aperture. A gasket is molded to the outer edge portion of the speaker surround such that the gasket is integrally bonded to the speaker surround.

A further example embodiment, as described herein, is another method of manufacture of a joint speaker surround and gasket. A gasket is molded to a gasket portion of a speaker surround blank. A speaker surround is then formed from the speaker surround blank. The speaker surround includes an outer edge portion and an inner edge defining a speaker cone aperture, and the speaker surround is formed such that the outer edge portion of the speaker surround corresponds to the gasket portion of the speaker surround blank. By these processes, the gasket is integrally bonded to the outer edge portion of the speaker surround.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the embodiments are best understood from the following detailed description when read in connection with the accompanying drawing. It should be understood that the various features of the drawing may not be to scale. Likewise, the dimensions of the various features may be altered for clarity. Included in the drawings and/or illustrations are the following figures:

FIG. 1A is a top plan drawing of an example joint speaker surround and gasket, as described herein;

FIG. 1B is a side cut-away drawing of the example joint speaker surround and gasket of FIG. 1A cut along dotted line 1B-1B of FIG. 1A;

FIG. 2 is a flowchart illustrating an example method of manufacture for an example joint speaker surround and gasket, as described herein;

FIG. 3 is a flowchart illustrating another example method of manufacture for an example joint speaker surround and gasket, as described herein.

### DETAILED DESCRIPTION

Speakers are included in a vast array of consumer electronic devices, including (but not limited to) computers, televisions, cell phones, smart phones, tablets, cd players, and digital music systems. The market for these consumer electronic devices is very competitive. Improvements in manufacturing techniques, especially those that simplify assembly and/or reduce production costs are highly useful.

Assembly of speaker systems in these consumer electronics devices may be complicated by the existence of multiple discreet components involved in the assembly process. Typically, the various components of the speaker unit are preassembled separately. In the typical preassembled speaker, the magnet is coupled to the speaker frame, as are the speaker surround and spider. The speaker surround and spider are coupled to the speaker cone so that the cone is centered both axially and radially, and so that the voice coil (which is couple to the speaker cone) is centered within the magnet. When the speaker is mounted to the device housing during final assembly, a gasket is commonly aligned between the speaker frame and the device housing to ensure a snug, airtight fit.

Particularly in smaller personal electronic devices, such as cell phones, both the speaker and the gasket are very small and their assembly often involves precise alignment of the small components in tight spaces.

Example embodiments, as described herein, may simplify assembly of these speaker-containing consumer electronic devices. These example embodiments include joint speaker surrounds and gaskets, and methods of manufacturing thereof. Manufacturing the speaker surround and gasket in a single integrally bonded element allows for final assembly of the speakers into a device housing without the additional complexity of having to align three components (two of which may be quite small) in a confined space.

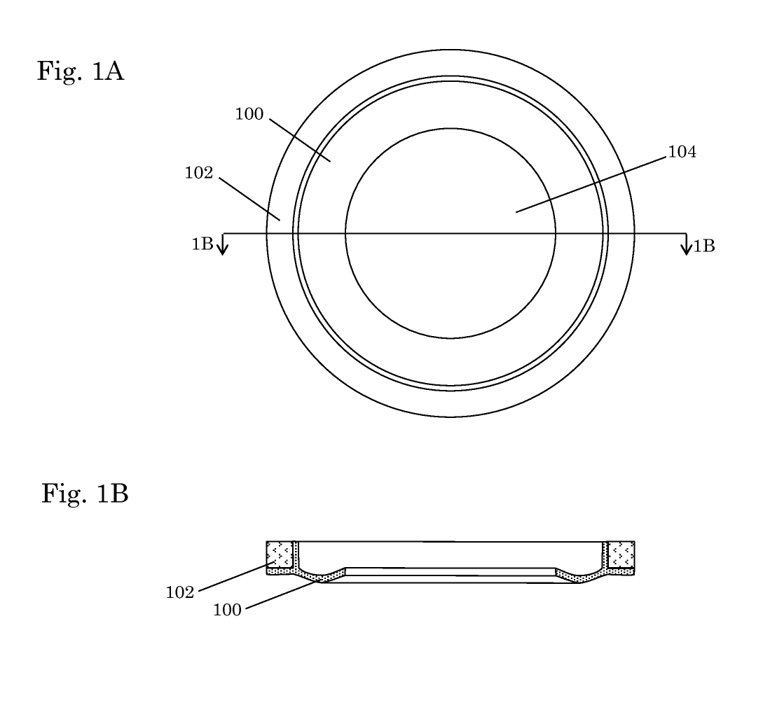

FIGS. 1A and 1B illustrate an example joint speaker surround and gasket as described herein. FIG. 1A shows a top plan view of the example joint speaker surround and gasket, while FIG. 1B show a cut-away side view of the joint speaker surround and gasket of FIG. 1A, cut along line 1B-1B. The example joint speaker surround and gasket includes speaker surround 100 and gasket 102. Gasket 102 is integrally bonded to the outer edge portion of speaker surround 100 forming an example joint speaker surround and gasket, as described herein.

The speaker surround has an inner edge defining speaker cone aperture 104 shaped to match the speaker cone of the speaker for which the example joint speaker surround and gasket is intended and an outer edge portion shaped to match the speaker frame and/or housing to which the example joint speaker surround and gasket is to be coupled. It is noted that the example joint speaker surround and gasket of FIGS. 1A and 1B is designed for a speaker that includes a round speaker cone; however, this choice of shape is merely illustrative and not intended to be limiting. It is contemplated that example embodiments of joint speaker surrounds and gaskets designed for speakers including other shaped speaker cones, such as oval, rounded rectangular, or rectangular speaker cones, may be produced as well.

Speaker surround 100 is formed of a surround material. The surround material is a flexible material such as: rubber; silicone; plastic; metal; cloth; paper; foam rubber; a plastic foam; or a composite material including fibers and a resin. The structure of speaker surround 100 in a plane perpendicular to the plane of speaker cone aperture 104 is designed so that the inner edge of the speaker surround is elastically movable relative to the outer edge portion in the direction normal to the plane of speaker cone aperture 104. Typically, speaker surround 100 may have a width between the outer edge portion and the inner edge that is significantly greater than its thickness in the direction normal to the plane of the speaker cone aperture. FIG. 1B illustrates one example speaker surround structure; however one skilled in the art may understand that this example cross-sectional structure, which is included for illustrative purposes, is merely one of many possible structures for example speaker surround 100 and is not intended as limiting.

Example gasket 102 is molded of an elastically compressible gasket material, such as: rubber; silicone; or elastomer. In some example embodiments, as described herein, the thickness of gasket 102 in the direction normal to the plane of speaker cone aperture 104 may be greater than the predetermined maximum travel of the inner edge of speaker surround 100 relative to the outer edge portion, i.e. the maximum displacement of the speaker cone during high volume use. This thickness may prevent damage to speaker surround 100 and the speaker cone that could occur if these speaker components were to impact a grill, other speaker cover, or other structural component that might be flush with the housing surface of the personal electronic device in which the speaker is to be mounted.

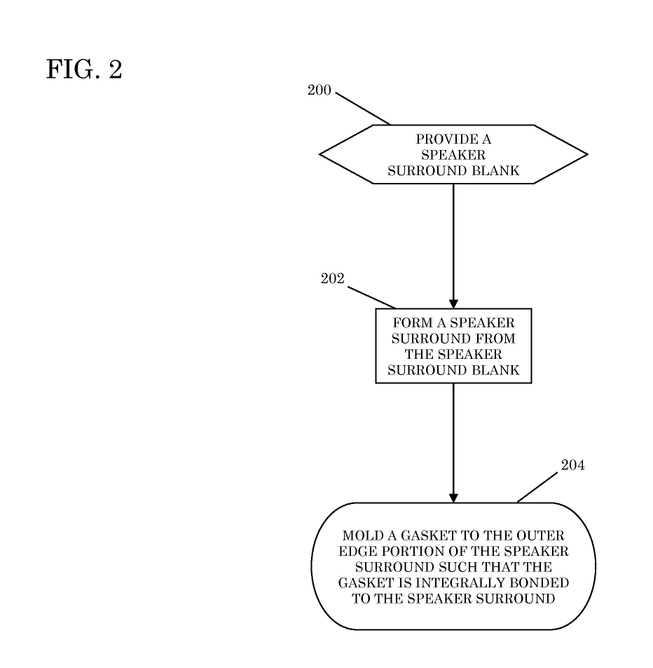

FIG. 2 is a flowchart illustrating an example method of manufacture of an example joint speaker surround and gasket, as described above with reference to FIGS. 1A and 1B. A speaker surround blank is provided, step 200. In some example embodiments, the speaker surround blank may be a bulk material sheet or plate. This sheet or plate may be formed of any of the surround materials described above with reference to the example joint speaker surrounds and gaskets of FIGS. 1A and 1B. Alternatively, the speaker surround blank may include a carrier and a speaker surround film formed on the carrier. The carrier may serve to provide additional structural strength and/or improve transportability during manufacture.

The speaker surround is formed from the speaker surround blank, step 202. The speaker surround includes an outer edge portion and an inner edge defining a speaker cone aperture, as described above with reference to the example embodiments of FIGS. 1A and 1B. A number of processes may be used, singly or in combination, for forming the speaker surround from the speaker surround blank. For example, the speaker surround blank may be stamped to form one or more of: the outer edge portion of the speaker surround; the inner edge of the speaker surround; and/or the structure of the speaker surround normal to the speaker cone aperture. The speaker surround may be die cut from the speaker surround blank to form the outer edge surrounding the outer edge portion and/or the inner edge of the speaker surround. Heat forming and/or plastic deformation may also be used to form the structure of the speaker surround normal to the speaker cone aperture. The speaker surround blank may also be etched. Etching may be particularly useful in the example situation when the speaker surround blank includes a speaker surround film formed on a carrier. Additionally, the speaker surround blank may be coated as part of the process of forming the speaker surround. For example, in the case when the speaker surround is formed of a composite material, the speaker surround blank may be formed of the fiber matrix of the composite material, and the resin binder may be coated onto the speaker surround after the speaker surround blank has been shaped by another process, such as die cutting, to form the speaker surround.

It is noted that, although a number of example processes of forming the speaker surround from the speaker surround blank have been provided, these example processes are merely illustrative and are not intended to be limiting.

Once the speaker surround has been formed, a gasket is molded to the outer edge portion of the speaker surround such that the gasket is integrally bonded to the speaker surround, step 204. A number of processes may be used for molding the gasket to the outer edge portion of the speaker surround.

One example process is injection molding. In this example process, the speaker surround is placed into an injection molding cavity for the gasket such that the outer edge portion of the speaker surround forms a portion of the surface of the injection molding cavity. Gasket material is injected into the injection molding cavity to fill the cavity. The gasket material is then set to form the gasket such that the gasket is integrally bonded to the speaker surround; and the completed joint speaker surround and gasket is removed from the injection molding cavity.

Another example process is compression molding. In this example process, the speaker surround is placed into a first portion of a compression molding cavity for the gasket. A predetermined amount of gasket material is deposited in the first portion of the compression molding cavity on the outer edge portion of the speaker surround. The second portion of the compression molding cavity is compressed into the deposited gasket material to form the gasket such that the gasket is integrally bonded to the speaker surround; and the completed joint speaker surround and gasket is removed from the injection molding cavity.

Whatever example process is used to mold the gasket to the outer edge portion of the speaker surround, that example process includes one or more means of bonding the material of the gasket to the material of the speaker surround. For example, the example molding process may supply a predetermined amount of heat and/or pressure that is sufficient to bond the speaker surround material to the gasket material. Alternatively, the example molding process may include supplying a predetermined amount of solvent, which is sufficient to bond the speaker surround material to the gasket material via a solvent welding process. The type and amount of solvent is dependent on the speaker surround material and the gasket material.

It is noted that, although a number of example processes of molding the gasket such that it is bonded to the speaker surround have been provided herein, these example processes are merely illustrative and are not intended to be limiting.

It is also noted that, if the speaker surround blank includes a carrier and a speaker surround film formed on the carrier, the speaker surround may be removed from the carrier before or after the gasket has been molded to the outer edge portion of the speaker surround. In one example embodiment, the carrier may be a tape on which a series of joint speaker surrounds and gaskets may be formed and these joint speaker surrounds and gaskets may remain attached to the carrier tape for transport until they are removed during assembly of the speaker.

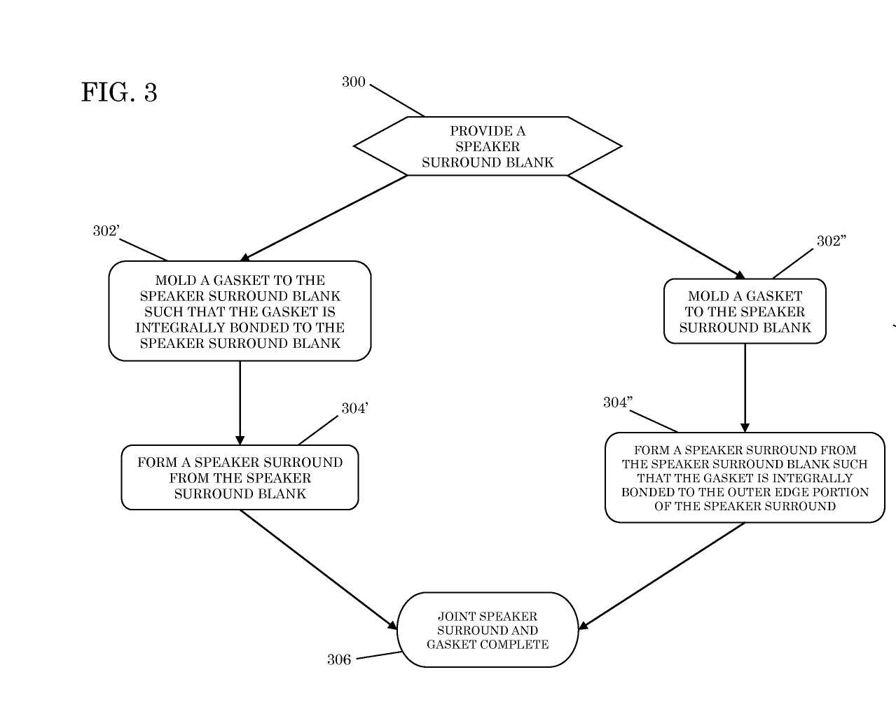

FIG. 3 illustrates two other related example methods of manufacture of a joint speaker surround and gasket, as described above with reference to FIGS. 1A and 1B. In both of these example methods, a speaker surround blank is provided, step 300. As in the example method of FIG. 2, the speaker surround blank may be a bulk sheet or plate, or a speaker surround film formed on a carrier.

In the first of the these two related example methods, a gasket is molded to a gasket portion of a speaker surround blank such that the gasket is integrally bonded to the speaker surround blank, step 302′. This molding step may be accomplished using any of the molding processes described above with reference to the example method of FIG. 2. Likewise, the integral bonding of the gasket to the speaker surround blank may involve any of the example bonding means described above with reference to the example method of FIG. 2.

The speaker surround is then formed from the speaker surround blank, step 304′, and the joint speaker and gasket is complete, step 306. The speaker surround includes an outer edge portion and an inner edge defining a speaker cone aperture, as described above with reference to the example embodiments of FIGS. 1A and 1B. The speaker surround is formed such that the outer edge portion of the speaker surround corresponds to the gasket portion of the speaker surround blank. Forming the speaker surround from the speaker surround blank may be accomplished using any of the example processes described above with reference to the example method of FIG. 2.

In the second of these two related example methods, a gasket is molded to a gasket portion of a speaker surround blank, step 302″. Except that unlike step 302′ of the other related example method of FIG. 3, the gasket is not integrally bonded to the speaker surround blank by molding the gasket to the speaker surround blank. However, this molding step may also be accomplished using any of the molding processes described above with reference to the example method of FIG. 2.

The speaker surround is then formed from the speaker surround blank such that the gasket is integrally bonded to the speaker surround, step 304″, and the joint speaker and gasket is complete, step 306. The speaker surround includes an outer edge portion and an inner edge defining a speaker cone aperture, as described above with reference to the example embodiments of FIGS. 1A and 1B. The speaker surround is formed such that the outer edge portion of the speaker surround corresponds to the gasket portion of the speaker surround blank. Forming the speaker surround from the speaker surround blank may be accomplished using any of the example processes described above with reference to the example method of FIG. 2. In this example method, the integral bonding of the gasket to the speaker surround blank may involve the application of sufficient heat and/or pressure during formation of the speaker surround from the speaker surround blank.

Thus, these two related example methods of FIG. 3 differ primarily in whether the gasket material becomes bonded to the speaker surround material during the molding of the gasket on the speaker surround blank, or during the formation of the speaker surround from the speaker surround blank. However, in both cases the end result is a joint speaker surround and gasket in which the gasket is integrally bonded to the speaker surround.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. A joint speaker surround and gasket, comprising:
a speaker surround formed of a surround material, the speaker surround having an inner edge defining a speaker cone aperture shaped to match a speaker cone and an outer edge portion shaped to match a housing; and
a gasket integrally bonded to the outer edge portion of the speaker surround, the gasket molded of a gasket material.

2. The joint speaker surround and gasket of claim 1, wherein the surround material is a flexible material.

3. The joint speaker surround and gasket of claim 2, wherein the speaker surround has a structure in a plane perpendicular to a plane of the speaker cone aperture such that the inner edge of the speaker surround is elastically movable relative to the outer edge portion in a direction normal to the speaker cone aperture.

4. The joint speaker surround and gasket of claim 3, wherein:
the speaker surround has a width between the outer edge portion and the inner edge and a thickness in the direction normal to the plane of the speaker cone aperture; and
the width is significantly greater than the thickness.

5. The joint speaker surround and gasket of claim 3, wherein:
the gasket material is elastically compressible; and
a thickness of the gasket in a direction normal to the plane of the speaker cone aperture is greater than a predetermined maximum travel of the inner edge of the speaker surround relative to the outer edge portion.

6. The joint speaker surround and gasket of claim 5, wherein the gasket material is one of: rubber; silicone; or elastomer.

7. The joint speaker surround and gasket of claim 2, wherein the surround material is one of: rubber; silicone; plastic; metal; cloth; paper; foam rubber; a plastic foam; or a composite material including fibers and a resin.

8. A method of manufacture of a joint speaker surround and gasket, the method comprising:
forming a speaker surround from a speaker surround blank, the speaker surround including an outer edge portion and an inner edge defining a speaker cone aperture; and
molding a gasket to the outer edge portion of the speaker surround such that the gasket is integrally bonded to the speaker surround.

9. The method of claim 8, wherein forming the speaker surround from the speaker surround blank includes at least one of:
stamping the speaker surround blank to form one or more of:
the outer edge portion of the speaker surround;
the inner edge of the speaker surround; or
structure of the speaker surround normal to the speaker cone aperture;
die cutting the speaker surround from the speaker surround blank to form one or more of:
an outer edge surrounding the outer edge portion of the speaker surround; or
the inner edge of the speaker surround;
heat forming the speaker surround blank to form structure of the speaker surround normal to the speaker cone aperture;
plastically deforming the speaker surround blank to form structure of the speaker surround normal to the speaker cone aperture;
etching the speaker surround blank; or
coating the speaker surround blank or the speaker surround.

10. The method of claim 8, wherein:
the speaker surround blank includes a carrier and a speaker surround film formed on the carrier; and
forming the speaker surround from the speaker surround blank includes forming the speaker surround in the speaker surround film.

11. The method of claim 10, wherein forming the speaker surround from the speaker surround blank further includes separating the speaker surround formed in the speaker surround film from the carrier of the speaker surround blank.

12. The method of claim 10, wherein:
molding the gasket to the outer edge portion of the speaker surround includes molding the gasket to the outer edge portion of the speaker surround formed in the speaker surround film such that the gasket is integrally bonded to the speaker surround; and
the method further comprises:
separating the joint speaker surround and gasket from the carrier of the speaker surround blank.

13. The method of claim 8, wherein molding the gasket to the outer edge portion of the speaker surround includes:
placing the speaker surround into an injection molding cavity for the gasket such that the outer edge portion of the speaker surround forms a portion of a surface of the injection molding cavity;
injecting gasket material to fill the injection molding cavity;
setting the gasket material to form the gasket such that the gasket is integrally bonded to the speaker surround; and
removing the joint speaker surround and gasket from the injection molding cavity.

14. The method of claim 8, wherein molding the gasket to the outer edge portion of the speaker surround includes:
placing the outer edge portion of the speaker surround on a first portion of a compression molding cavity for the gasket;
depositing a predetermined amount of gasket material in the first portion of the compression molding cavity on the outer edge portion of the speaker surround;
compressing a second portion of the compression molding cavity into the deposited gasket material to form the gasket such that the gasket is integrally bonded to the speaker surround; and
removing the joint speaker surround and gasket from the compression molding cavity.

15. The method of claim 8, wherein:
the speaker surround is formed of a speaker surround material;
the gasket is formed of a gasket material; and
molding the gasket to the outer edge portion of the speaker surround includes supplying one of:
a predetermined amount of heat in the molding process, the predetermined amount of heat being sufficient to bond the speaker surround material to the gasket material;
a predetermined amount of pressure in the molding process, the predetermined amount of pressure being sufficient to bond the speaker surround material to the gasket material;
a predetermined combination of heat and pressure in the molding process, the predetermined combination of heat and pressure being sufficient to bond the speaker surround material to the gasket material; or
a predetermined amount of solvent, the predetermined amount of solvent being sufficient to bond the speaker surround material to the gasket material.

16. A method of manufacture of a joint speaker surround and gasket, the method comprising:
molding a gasket to a gasket portion of a speaker surround blank; and
forming a speaker surround from the speaker surround blank, the speaker surround including an outer edge portion and an inner edge defining a speaker cone aperture, the speaker surround being formed such that the outer edge portion of the speaker surround corresponds to the gasket portion of the speaker surround blank;
wherein the gasket is integrally bonded to the outer edge portion of the speaker surround.

17. The method of claim 16, wherein one of:
molding the gasket to the gasket portion of the speaker surround blank includes integrally bonding the gasket to the gasket portion of the speaker surround; or
forming the speaker surround from the speaker surround blank includes integrally bonding the gasket to the outer edge portion of the speaker surround.

18. The method of claim 16, wherein molding the gasket to the gasket portion of the speaker surround blank includes one of:
injection molding the gasket to the gasket portion of the speaker surround blank; or
compression molding the gasket to the gasket portion of the speaker surround blank.

19. The method of claim 16, wherein forming the speaker surround from the speaker surround blank includes at least one of:
stamping the speaker surround blank;
die cutting the speaker surround blank;
heat forming the speaker surround blank;
plastically deforming the speaker surround blank;
etching the speaker surround blank; or
coating the speaker surround blank.

20. The method of claim 16,
further comprising forming a speaker surround film on a carrier to form the speaker surround blank;
wherein;
the gasket portion of the speaker surround blank is on a surface of the speaker surround film; and
forming the speaker surround from the speaker surround blank includes forming the speaker surround in the speaker surround film.

21. The method of claim 20, further comprising separating the joint speaker surround and gasket from the carrier of the speaker surround blank.
